(19) United States
(12) Patent Application Publication
(10) Pub. No.: US 2011/0005983 A9
(43) Pub. Date: Jan. 13, 2011

(54) Chip sorting device

(75) Inventors: Ernst Blaha, Tullnerbach (AT); Peter Krenn, Neufeld (AT)

Correspondence Address: TRASKBRITT, P.C. /SHUFFLE MASTER, P.O. BOX 2550, SALT LAKE CITY, UT, 84110, US

(73) Assignee: Shuffle Master GmbH & Co KG

(21) Appl. No.: 11/590,340

(22) Filed: Oct. 30, 2006

Related U.S. Application Data
(63) Continuation of application No. 11/004,006, filed on Dec. 3, 2004.
Application No. 11/004,006 is a continuation of application No. PCT/AT03/00149, filed on May 26, 2003.

(30) Foreign Application Priority Data
Jun. 5, 2002 (AT) GM 359/2002

(51) Int. Cl. B07B 13/00

(52) U.S. Cl. 209/686

(57) ABSTRACT

The invention relates to a sorting device for sorting gaming chips and counters. Said device comprises a collection container (1) located on a base frame (36), an adjoining oblique transport disc (3) for receiving and separating the gaming chips and counters (27), a characteristic identification system positioned in the vicinity of the transport disc (3), in addition to a transfer device (11), which distributes the gaming chips and counters (27) that are sorted according to characteristics in removal units (12) with a preferably U-shaped cross-section. The invention is characterised in that the gaming chips and counters (27) are transferred directly from the transport disc (3) to the removal units (12), the radially external region of said transport disc (3) having recesses (8), into which the gaming chips and counters (27) are separated. The device is provided with at least one ejector (14), which can be inserted at least partially from one side of the transport disc (3) into the recesses (8), in order to lift the lower edge (15) of the gaming chips and counters (27) above the front face (3a) of the transport disc (3) lying opposite the ejector (14), whereby a blade (16), located on a removal unit (12), slides under the gaming chip or counter (27) and the latter is placed on said blade.

The invention relates to a sorting device for gaming chips and counters, in particular to gaming chips and counters of different color and in accordance with the preamble of claim 1.

Sorting devices for gaming chips have been known for a long time. GB 2061490 discloses a device which distributes gaming chips, which are collected by a transport chain and passed by a feature recognition system, from the chain into appropriate removal units. A disadvantage of this solution is the high space requirement for the chain. A further disadvantage is the high manufacturing costs, because the chain comprises many individual members, each of these members being provided in addition with a spring-loaded pin for distributing gaming chips.

GB 2254419 describes a device, in which the gaming chips are first collected by a transport disc and then transferred to a chain, recognized there, and distributed to a removal unit. This arrangement requires less space than the aforementioned device. Nevertheless, it uses resilient elements to retain individual gaming chips, transferred from the transport disc to the chain, in the chain itself. These resilient elements precisely, however, accept only gaming chips with a largely uniform diameter, because gaming chips with a diameter greater than the nominal diameter can be transferred to the chain only at a high load or not at all; gaming chips with a diameter smaller than the nominal diameter cannot be reliably retained and fall out of the chains on the way to distribution to the removal units. The additional chain leads to additional manufacturing costs.

U.S. Pat. No. 6,381,294 discloses a chip-sorting device in which the conveyance of the chips is effected by a chain. This transport means is very expensive to maintain, however.

The object of this invention is to avoid these disadvantages and to propose a sorting device of the aforementioned type, which has low manufacturing costs with a low space requirement and with which the gaming chips and counters may have highly different dimensions.

As taught by the invention, this object is achieved with a sorting unit of the aforementioned type by means of the characteristic features of claim 1.

The proposed measures make it possible to convey and sort chips and counters of different dimensions by means of a cost-effective and simple transport device. The technically expensive and maintenance-intensive insertion of a chain conveyor is not necessary. The sorting device is robust to gaming chips and counters of different size. By the raising of the gaming chips by the ejector and the simultaneous rotation of the transport disc, the chips are automatically lifted out of the transport disc and organized in a removal unit.

Thereby, the features of claims 2 and 3 provide the advantage of a very gentle and careful distribution of the chips and counters into the removal units.

The features of claim 4 assure that the distribution movement for a single gaming chip or counter is always constant relative to the movement of the transport disc, even when the transport speed changes.

The organization of the gaming chips and counters, in conjunction with the feature recognition system, can be easily programmed and controlled by means of the features of claim 5.

Several removal units can be filled simultaneously by means of the features of claim 6.

A portion of the sorted gaming chips and counters can be removed from the removal units in a simple manner by means of the features of claim 7.

The features of claims 8 and 9 can adjust the number of gaming chips and counters to be removed from the removal units.

To accomplish this, a tilting movement of the removal lever is provided according to claim 10.

The removal lever is always proximate to the gaming chips and counters by means of the features of claim 11.

By means of the features of claim 12, it can be determined when a removal unit has been totally filled, whereupon gaming chips and counters can no longer be sorted into this removal unit.

The conveying speed of the gaming chips and counters in the system is adjusted by means of the characteristics features of claim 13.

The characteristic features of claims 14 and 15 describe the preferably employed feature recognition system.

The base frame can be adjusted in height and adapted to the specific table heights by means of the characteristic features of claim 16.

The invention will now be illustrated in greater detail by the drawing. Here:

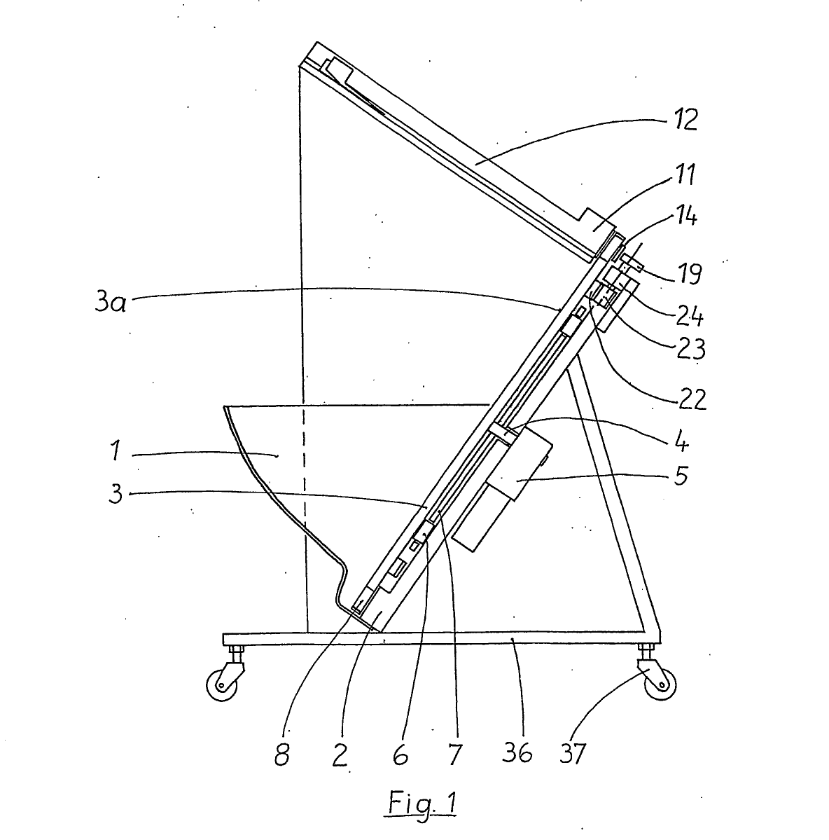

FIG. 1 shows a schematic drawing of the sorting unit of the invention without a housing

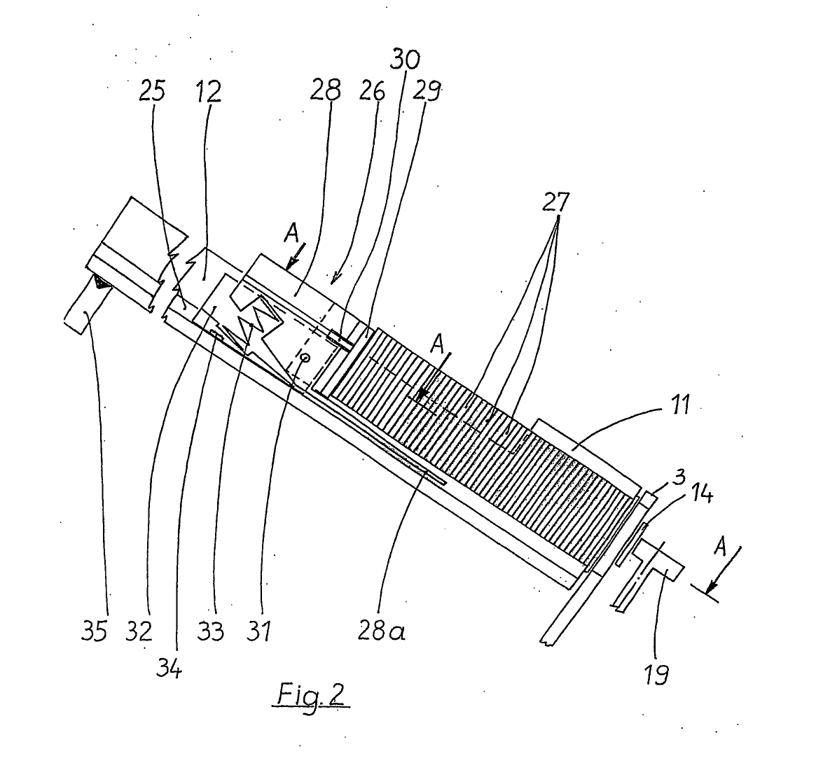

FIG. 2, a cross section through the removal unit

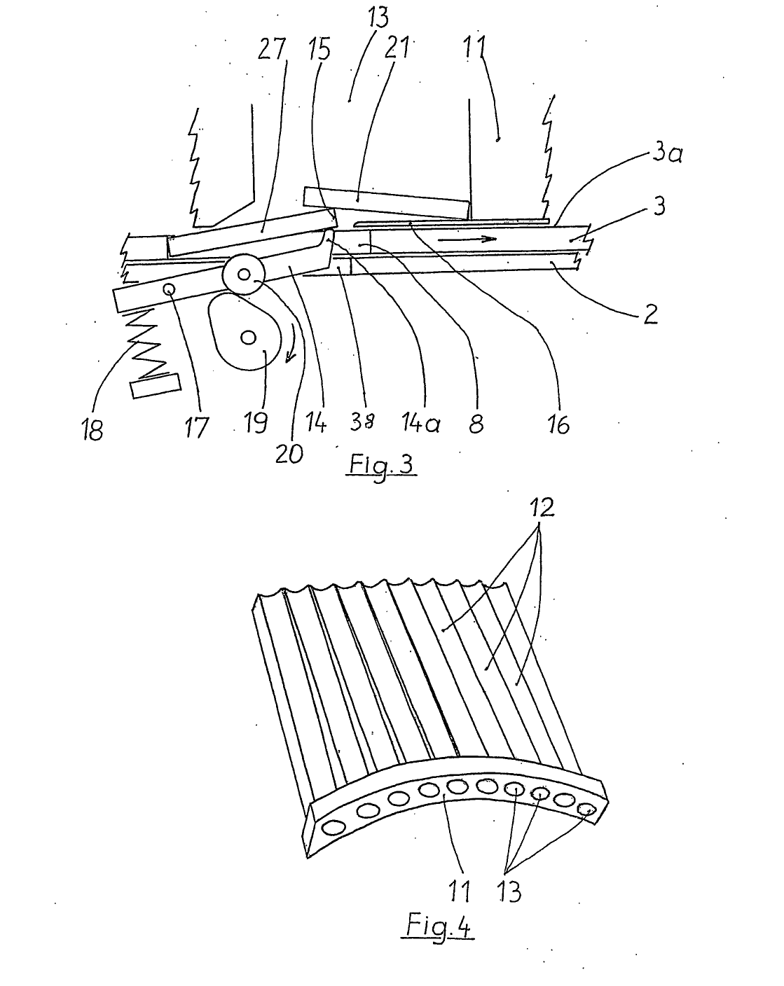

FIG. 3, a section through the chip and counter distribution unit along line AA of FIG. 2

FIG. 4, a possible spatial form of the removal units

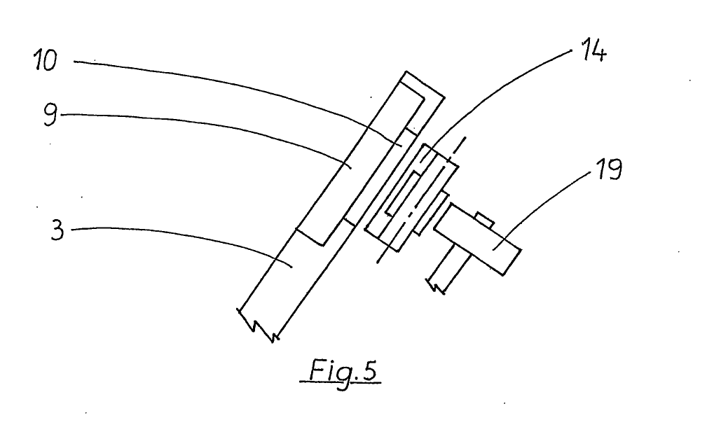

FIG. 5, an alternative depiction of the hopper disc

The device consists of an upwardly open collection container 1 for used gaming chips and counters, also called a “hopper,” which is fixed to the sloping base plate 2.

The conveying device forms a circular disc 3, the “hopper disc,” and is mounted drivably on shaft 4. The shaft 4 is supported by the base plate 2 and is connected to the drive 5.

The hopper disc 3 is supported axially by a plurality of rolling elements 6, which in turn are guided in cage plate 7. This axial support may be omitted, if the central support of the shaft 4 can absorb the axial forces and the hopper disc 3 is made suitably rigid.

In use, the gaming chips and counters 27 are collected in the hopper 1, where due to gravity they are taken up in the hopper disc at the lowest point of the hopper 1 by circular apertures 8, arranged around the perimeter of the hopper disc 3. The apertures have at least the diameter of the largest circular chip or counter, which is to be processed. The depth of the apertures in the embodiment results from the thickness of the hopper disc and constitutes at least the thickness of the thickest counter. During the use of circular apertures, according to FIG. 1, the gaming chips and counters 27 slide on the base plate 2 during the rotation of the hopper disc 3. FIG. 5 shows an alternative collection of chips and counters in blind holes 9. These are open toward the side of the hopper 1 and closed toward the side of the base plate 2. Thereby, the back of the hopper disc 3 must have an annular circumferential groove 10, which substantially has the width of the ejector 14 of FIG. 3.

The hopper disc 3 conveys the gaming chips and counters 27, taken up in any order by the recesses 8, upwards at an angle of approximately 135°, whereby they are passed before a color sensor, which differentiates the chips and counters based on their color combination and size. Depending on chip color and pattern, the sensor conveys a signal to the microprocessor control (not shown) of the machine. This microprocessor control decides, based on a freely programmable assignment of colors, to which of the removal units 12 each of the conveyed gaming chips and counters 27 is distributed.

Alternatively, recognition of the gaming chips and counters 27 can occur by means of a spectrometer in the feature recognition system, which for differentiation detects the wavelengths of the color codes undetectable by the human eye. To accomplish this, the gaming chips and counters 27 must be provided with such color codes.

After recognition, the gaming chips and counters 27 are distributed into the removal units 12. This area extends at about 90° to the hopper disc 3.

FIG. 4 shows the transfer device 11, which is designed substantially as an arc-like sector and has a number of apertures 13, in which the different gaming chips and counters 27, sorted cleanly per aperture, are distributed from the hopper disc 3 into removal units 12. Ten apertures are used in the exemplary embodiment.

The actual distribution of gaming chips and counters is readily evident from FIG. 3, which shows a section along the line AA of FIG. 2 through one of the apertures 13 in the transfer element 11. Each of the apertures 13 is assigned an ejector 14, which after activation is inserted into the recesses 8 through a slit 38 in the base plate 2 and raises the corresponding gaming chip or counter 27 during the movement of the hopper disc 3. The ejector 14 is mounted so that it swivels around the shaft 17 and is pushed against the cam 19 via spring 18. To enable a wear-free rolling of the cam 10 on the ejector 14, said ejector can be provided expediently with a roller 20.

By means of the continuous movement of the hopper disc 3, the gaming chip or counter 27 is pushed over the blade 16, where if finally rests. If another counter 21 is located on the blade, it is unavoidably raised by means of the lifting motion of the counter 27, so that counter 27 comes to lie finally under counter 21. This process is repeated as long as gaming chips or counters 27 of the same type are being conveyed, so that the removal units 12 fill with counters.

FIG. 4 shows the removal units 12 directly adjacent to the transfer element 11, said units which run next to one another expediently from the arc-like arrangement in the area of the element 11 to a straight or nearly straight arrangement to facilitate the easy removal from all sides of gaming chips or counters deposited herein.

FIG. 1 shows the drive of the cam 19. On the side, facing away from hopper 1, of the hopper disc 3, there is an annular ring gear 22 that drives the pinion 23 associated with a cam. The microprocessor control of the machine actuates a magnetic coupling 24, associated with a cam 19, and thereby creates the connection between the pinion 23 and the cam 19 for a cam rotation. This assures that the ejector 14 always performs the same movement relative to the hopper disc 3, independently of the conveying speed of hopper disc 3.

If a jam were to occur during the transfer of the gaming chips and counters into the removal units, a short return motion of the hopper disc 3 is provided. To recognize a jam, the current of the drive motor 5 can be monitored, or the movement of the hopper disc 3 can be queried directly via a suitable sensor.

To increase the conveying performance and simultaneous reduction of wear on all moving parts of the machine, adjustment of the conveying speed of the machine to the quantity of counters to be sorted in each case is recommended. The speed can be set depending on whether and how many free recesses 8, i.e., not filled with gaming chips or counters 27, in the hopper disc 3 can be detected by the counter recognition system.

The removal units 12 for sorted gaming chips and counters can be seen in FIG. 2 and consist substantially of upwardly open chip transporters, each respectively provided with a central groove 25. For the expedient removal of gaming chips and counters 27 from the removal units, a special device is provided, a “cutter” 26, which glides downward in one of the grooves 25 by means of gravity and thus abuts constantly the reserve gaming chips and counters 27 in the removal units. The cutter has an L-shaped lever 28, the thin arm 28 of which lies underneath the gaming chips and counters. At the same time, a stop 29 always abuts the gaming chips and counters and in turn is supported by element 28 via an adjusting screw 30. The elements 28 and 29 are connected in a swiveling manner by means of the shaft 31 with the body 32 gliding within the groove 25. Through pressure applied in the direction of arrow A, a predetermined quantity, preferably 20 pieces, of gaming chips or counters can be raised by the lower arm 28a of the L-shaped lever and are thus freely removable from the total quantity of gaming chips or counters 27.

The quantity of gaming chips and counters that can be lifted by the cutter 26 can be finely adjusted or matched to the precise thickness of the gaming chips and counters via the adjusting screw 30.

The use of a pressure spring 33 assures that the thin leg of the L-shaped lever 28 always remains underneath the counters, but this is not absolutely required.

In order to prevent the distribution of more gaming chips or counters into one of the removal units 12 than can be accommodated by its stack length, every removal unit 12 is provided with a sensor 35. As soon as the cutter 26 reaches its endpoint, the sensor 35 sends a signal to the microprocessor control, which then no longer ejects gaming chips and counters 27 into the particular channel. The sensor 35 can, for example, be either an optical or magnetic sensor. To that end, a permanent magnet 34 must be provided in the bottom of the cutter 26.

The device can be designed adjustable with simple means to different table or operator heights. As is evident from FIG. 1, the casters 37 are attached to the base frame 36 to be adjustable in height.

1-16. (canceled)

17. A casino chip sorting device, comprising:
a transport disc with multiple recesses for collecting individual chips,
an ejector that extends through a recess from beneath the transport disc to move a disc that is in the recess, and
a blade having an upper surface that receives a casino chip moved by the ejector;
wherein a processor associated with the casino chip sorting device is programmed to recognize a jam.

18. The casino chip sorting device of claim 17 wherein a motor provides power to move the transport disc and power in the motor is monitored by the processor to detect the jam.

19. The casino chip sorting device of claim 17 wherein the individual chips are sensed in the transport disc and the sensor is assessed to determine the presence of a jam.

20. The casino chip sorting device of claim 17 wherein a drop in activity of the transport disc is sensed to determine the jam.

21. The casino chip sorting device of claim 17 wherein functions of the transport disc are monitored to determine the jam.

22. The casino chip sorting device of claim 17 wherein a drop in activity of the chip sorting device is sensed to determine the existence of the jam.

23. The casino chip sorting device of claim 17 wherein after detection of a jam, the processor provides for a short return motion of the transport disc.

24. The casino chip sorting device of claim 17 wherein upon recognition of the jam the processor directs a return motion of the transport disc.

25. A sorting device for the sorting of gaming chips comprising a base frame, a collection container, an oblique transport disc adjoining the collection container, the oblique transport disk separating and receiving gaming chips, a gaming chip characteristic identification system positioned adjacent the transport disc, a transfer device distributing the gaming chips to removal units according to characteristics identified in the gaming chip characteristic identification system, removal units having a U-shaped cross-section; the sorting device having a transport for transferring the gaming chips directly from the transport disc to the removal units, and a radially external region of the transport disc containing recesses into which the gaming chips are separated, the sorting device provided with at least one ejector that can be inserted at least partially from one side of the transport disc into the recesses to lift an edge of the gaming chips above a front face of the transport disc lying opposite the at least one ejector, whereby a blade located on a removal unit slides under the gaming chip with a lifted edge, and the gaming chip with a lifted edge is placed on the blade wherein a side of the transfer disc not adjacent to the collection container has a cogwheel; and
wherein a processor associated with the casino chip sorting device is programmed to recognize a jam.

26. The sorting device of claim 25 further comprising a coupling adjacent the cogwheel.

27. The sorting device of claim 25 wherein after detection of a jam, the processor provides for a return motion of the transport disc.

28. The sorting device of claim 27 wherein at least one removal unit and ejector is aligned with a magnetic coupling and pinion.

29. The sorting device of claim 27 wherein at least one removal unit comprises an L-shaped removal lever having a longer arm, which longer arm is in a groove that runs a length of a floor of the removal unit and goes under an area where the gaming chips are supported.

30. The sorting device of claim 25 wherein a drop in activity of the chip sorting device is sensed to determine the existence of the jam.

31. The sorting device of claim 25 wherein a motor provides power to move the transport disc and power in the motor is monitored by the processor to detect the jam.

32. The sorting device of claim 30 wherein the removal lever may swivel around an axle at a parallel level to a movement direction of the shorter arm.

33. The sorting device of claim 30 wherein that the shorter arm of the removal lever encounters a spring, which pushes the shorter arm against the gaming chips.

34. The sorting device of claim 25 wherein at least one removal unit has a sensor to detect when the removal unit is at a full level.

35. The sorting device of claim 29 wherein the recognition system utilizes sensors to differentiate size and color combinations of gaming chips.

36. The sorting device of claim 25 wherein a drop in activity of the transport disc is sensed to determine the jam.
